(19) United States
(12) Patent Application Publication
(10) Pub. No.: US 2026/0073662 A1
(43) Pub. Date: Mar. 12, 2026

(54) ENCODER NEURAL NETWORKS WITH POWER CONSTRAINED LATENT REPRESENTATIONS

(71) Applicant: Google LLC, Mountain View, CA (US)

(72) Inventors: William R. Mark, Mountain View, CA (US); Andrey Zhmoginov, Seattle, WA (US)

(21) Appl. No.: 19/186,201

(22) Filed: Apr. 22, 2025

Related U.S. Application Data
(60) Provisional application No. 63/637,328, filed on Apr. 22, 2024.

(51) Int. Cl. G06V 10/72; G06V 10/30; G06V 10/764; G06V 10/776; G06V 10/82; G06V 10/96

(52) U.S. Cl. CPC G06V 10/72; G06V 10/30; G06V 10/764; G06V 10/776; G06V 10/82; G06V 10/96

(57) ABSTRACT

Methods, systems, and apparatus, including computer programs encoded on a computer storage medium, for training an encoder neural network to minimize the capacity of an encoded representation of an input observation subject to a per-observation distortion constraint.

### CROSS-REFERENCE TO RELATED APPLICATIONS

This application claims priority to U.S. Provisional Application No. 63/637,328, filed on Apr. 22, 2024. The disclosure of the prior application is considered part of and is incorporated by reference in the disclosure of this application.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that uses an encoder neural network to generate encoded representations of input observations. More specifically, this disclosure describes techniques for training the encoder neural network to minimize the capacity of an encoded representation of an input observation subject to a per-observation distortion constraint. The capacity of the encoded representation refers to how much information about the input observation is contained within the encoded representation. That is, the encoder neural network can be trained to target specific levels of distortion in a reconstruction of the input observation generated from the encoded representation generated by the encoder neural network while minimizing the capacity of the encoded representation of the input observation.

Particular embodiments of the subject matter described in this specification can be implemented as to realize one or more of the following advantages.

The techniques described in this specification train an encoder neural network to generate more useful encoded representations that can then be used for downstream tasks.

In particular, unlike other approaches to balancing between (i) restricting the amount of information flowing through a bottleneck defined by the encoder neural network (the “capacity”) and (ii) minimizing distortion of the reconstruction generated from the information, the described techniques can fix the distortion for each observation and allow the amount of information to vary such that the distortion constraint is satisfied. In other words, the described techniques can minimize the amount of information used to represent an observation while maintaining a target distortion by, during training, enforcing a constraint that matches the distortion of the reconstruction of the observation to a specified distortion value. By training the encoder neural network to minimize the capacity, e.g., the amount of information, of an encoded representation of the training observation subject to a per-observation distortion constraint, the system can effectively train the encoder neural network to target specified levels of distortion, unlike other techniques that minimize a blend of capacity and distortion. As a result, these target distortion encoded representations result in higher distortion accuracy for any given distortion target and can be more useful for a variety of downstream tasks.

As a specific example, modern self-supervised image models generally operate on fixed rate, e.g., a fixed amount of information, tokens represent each image patch. However, it would be more usable to use variable-rate tokens that represent each patch to within a specific distortion threshold, using the techniques described in this specification.

As another example, the system can dynamically adapt to different compression requirements using the target distortion encoded representations. For example, the system can be tailored to provide higher quality reconstructions when needed or more efficient compression when storage and bandwidth is limited. As a specific example, the system can optimize reconstruction of an input observation on an edge-device by targeting the lowest level of distortion possible considering the computational constraints of on-device processing.

The details of one or more embodiments of the subject matter of this specification are set forth in the accompanying drawings and description below.

Other features, aspects, and advantages of the subject matter will become apparent from the description, drawings, and the claims.

### BRIEF DESCRIPTION OF THE DRAWINGS

FIG. 1 shows an example training system.

FIG. 2. is a diagram that illustrates an example training process of the example training system.

FIG. 3A illustrates the ability of the trained encoder to target distortion. FIG. 3B illustrates the performance of the trained encoder in comparison with other classical algorithms.

FIG. 4 is a flow diagram of an example process of constraining the signal power of an encoded representation.

FIG. 5 is a flow diagram an example process of adding noise to the constrained encoded representation.

FIG. 6 is a flow diagram of an example process for training the encoder and decoder neural networks.

Like reference numbers and designations in the various drawings indicate like elements.

### DETAILED DESCRIPTION

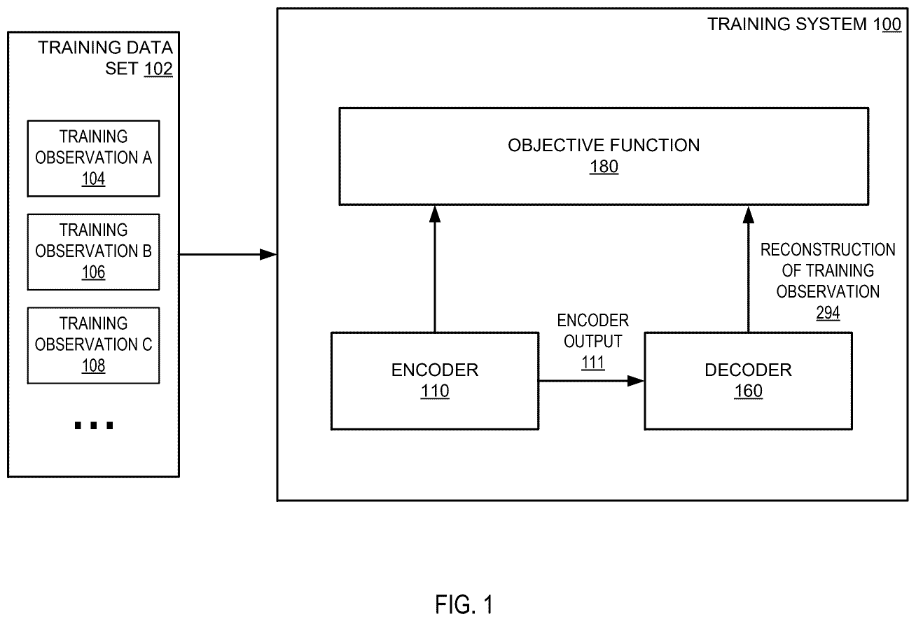

FIG. 1 shows an example training system 100. The training system 100 can include an encoder neural network 110 and a decoder neural network 160.

The training system 100 is an example of a system implemented as computer programs on one or more computers in one or more locations, in which the systems, components, and techniques described below can be implemented.

The encoder neural network 110 is a neural network that is configured to process an input observation to generate an encoder output.

For example, the input observations can be images, i.e., so that the encoder neural network 110 can process the intensity values of the pixels of the images.

As another example, the input observations can be audio data that represent audio signals, e.g., audio waveforms, compressed or companded audio waveforms, or spectrograms.

As another example, the input observations can be videos, i.e., so that the encoder neural network 120 can process the intensity values of the pixels of the video frames of the video frames in the video.

As another example, the input observations can be other types of sensor data, e.g., point clouds representing Lidar readings, radar readings, and so on.

The encoder output includes an initial latent vector representing at least a portion of the input observation. A “latent vector” as used in this specification is a vector of numerical values, e.g., floating point values or other types of numerical values, having a specified dimensionality, i.e., having a specified number of elements. The vector is referred to as a “latent” vector because the vector is an output of a neural network by processing an input rather than an observation that is received as input by the system 100.

For example, the encoder output can include a single initial latent vector representing the input observation.

As another example, the encoder output can include multiple initial latent vectors, each representing a different portion of the input observation. As one example of this, when the observations are images, the encoder output can include multiple initial latent vectors, each representing a different region of the image. As another example of this, when the observations are videos, the encoder output can include multiple initial latent vectors, each representing a different region of one of the video frames of the video. As another example of this, when the observations are audio signals, the encoder output can include multiple initial latent vectors, each representing a different time window within the audio signal.

In some implementations, the encoder output also includes a power output that defines the noise power for the initial latent vector.

In this specification, noise power can represent the magnitude or intensity of noise added to the initial latent vector. In this example, the power output can represent the noise power to be added to the initial latent vector to generate a final latent vector. Generating a final latent vector from the initial latent vector will be described below.

For example, the power output can define the noise power for a single initial latent vector representing the input observation. For example, the power output for a given latent vector can be a single scalar value.

As another example, the power output can define one or more noise powers for the multiple initial latent vectors. M ore specifically, each initial latent vector of the multiple latent vectors can have a respective noise power that may differ from the other noise powers of the multiple latent vectors.

The encoder neural network 110 can be any appropriate encoder neural network that is configured to receive an input observation and to generate (i) an encoded representation of the input observation that includes one or more latent vectors and (ii) one or more power outputs.

Generally, the encoder neural network 110 can have any appropriate architecture, e.g., can be a Transformer neural network, a vision Transformer (ViT) neural network, convolutional neural network, e.g., a ResNet, a recurrent neural network, and so on.

As an example, the encoder neural network 110 can be a Transformer neural network that can process the input observation through a set of self-attention layers to generate the encoder output.

Using a Transformer neural network, the input observation, represented as a sequence of tokens, can be embedded using an embedding layer to map each token to a high-dimensional vector. The Transformer can then apply one or more self-attention mechanisms to the high-dimensional vector through a series of one or more self-attention layers to generate the encoder output.

As another example, an encoder neural network 110 can be a convolutional neural network (CNN) that can process the input observation through a series of convolutional layers to generate the encoder output of the input observation.

The decoder neural network 160 can receive the final latent vector as input and generate a reconstruction of the input observation 294.

The decoder neural network 160 can be any appropriate decoder neural network that is compatible with the encoder neural network 110 and configured to receive one or more latent vectors each representing at least portion of the input observation and to process the one or more latent vectors generate a reconstruction of the input observation 294.

Generally, the decoder neural network 160 can have any appropriate architecture, e.g., can be a Transformer neural network, a vision Transformer (ViT) neural network, convolutional neural network, e.g., a ResNet, a recurrent neural network, and so on.

As an example, the decoder neural network 160 can be a Transformer neural network that can process the one or more latent vectors through a set of self-attention layers to generate the reconstruction of the input observation.

As another example, the decoder neural network 160 can be a convolutional neural network that can process the one or more latent vectors through a series of transposed convolutional layers to generate the reconstruction of the input observation.

The training system 100 can train the encoder neural network 110 and the decoder neural network 160 jointly on an objective function 180 using a training data set 102. In the description which follows, the phrase “joint training” should be understood to refer to the joint training of the encoder neural network 110 and the decoder neural network 160.

More specifically, the objective function 180, for any given input observation, minimizes a capacity of the encoded representation of the input observation, i.e., of the one or more latent vectors that are provided as input to the decoder neural network 160, subject to a per-observation distortion constraint.

In this specification, capacity refers to the amount of information or complexity that the encoder neural network can capture and represent in a latent vector that represents the input observation. That is, the capacity of the encoded representation is a measure of how much information about the input observation is contained within the encoded representation. As a particular example, capacity can be based on the number of bits that are required to represent the encoded representation under some compression scheme. M ore specifically, minimizing the capacity of the encoded representation of the input observation generally can refer to reducing the complexity of the latent vector of the input observation.

In this specification, distortion refers to the difference between the input observation and the reconstruction of the input observation generated by the decoder neural network 160. That is, distortion is the measure of how accurately the decoder neural network can reconstruct the input observation from the encoded latent representation. Thus, higher distortion refers to a larger difference between the input observation and the reconstruction, while lower distortion refers to a smaller difference between the input observation and the reconstruction.

During encoding of an input observation to generate an encoded representation, the encoder neural network must balance capacity and distortion. That is, the encoder neural network has to restrict the amount of information represented in the lower-dimensional latent vector, but cannot restrict too much or the reconstruction of the input observation will differ greatly from the original input observation. That is, because the latent vector is lower-dimensional than the original input observation, the encoder neural network has to restrict the amount of information to focus on extracting the most relevant features of the input observation as well as compress the data into a more manageable representation for further processing.

The training data set 102 generally includes multiple training observations. For example, the training data set 102 can include training observation A 104, training observation B 106, and training observation C 108.

For each training observation in a training iteration, the encoder neural network 110 can receive the input observation, e.g., training observation A 104, and generate an encoder output 111. As described above, the encoder output 111 can include (i) an initial latent vector representing at least a portion of the input observation and (ii) a power output that defines a noise power for the initial latent vector.

From the encoder output 111, the training system 100 can determine a scaling factor from the power output and apply the scaling factor to the initial latent vector to generate a final latent vector representing at least the portion of the training observation and having a constrained signal power.

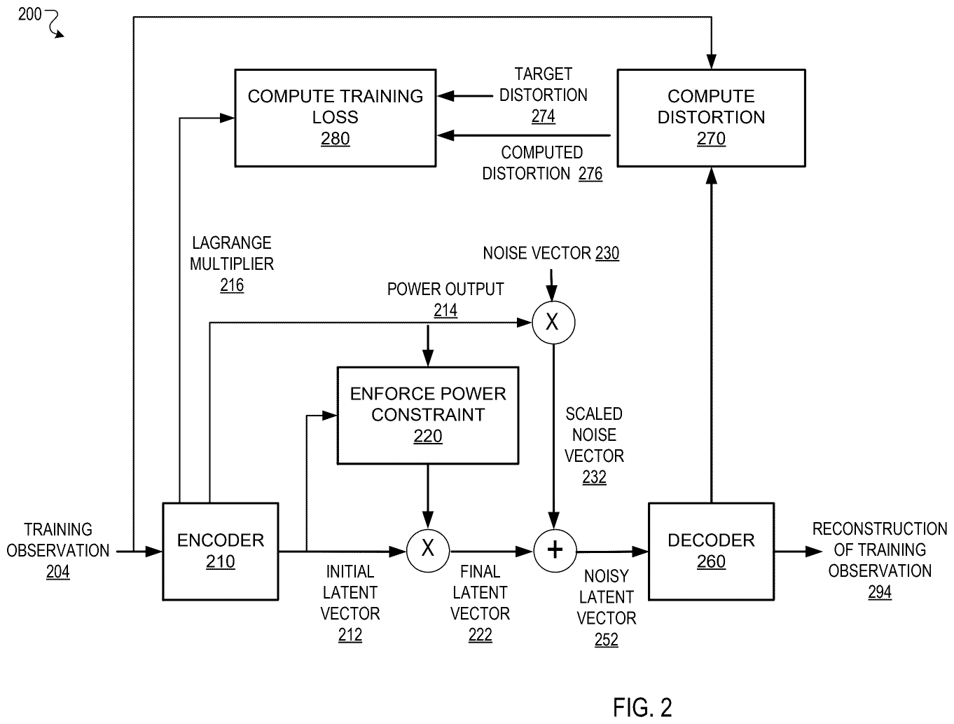

As described above, in some cases, the encoder output 111 can include multiple latent vectors. In this example, the system 100 can scale each of the multiple latent vectors to generate multiple final latent vectors. That is, the system 100 can determine a respective scaling factor from the power output for each of the multiple latent vectors and apply the scaling factor to the respective initial latent vector to generate a final latent vector representing at least the portion of the training observation that the initial latent vector represents and having a constrained signal power. In some implementations, the final latent vector(s) are noisy final latent vectors as described in further detail below with reference to FIG. 2.

As described above, in some implementations, the multiple latent vectors can have the same noise power. In some other implementations, the multiple latent vectors can have different noise powers.

That is, when generating the final latent vectors, the training system 100 can enforce a power constraint that constrains the signal power, e.g., the capacity or amount of information used to represent the observation of the final latent vector relative to the noise power.

The enforcement of the power constraint and the generation of the final latent vector are described in further detail below with reference to FIG. 2.

The decoder neural network 160 can then receive the final latent vector(s) of the encoded representation and generate a reconstruction of the training observation 294, e.g., a reconstruction of training observation A 104.

For each training observation in the training data set 102, the training system 100 can train the encoder neural network 110 and the decoder neural network 160 jointly on the objective function 180 that minimizes a capacity of the encoded representation of the training observation subject to a constraint on a per-observation distortion of the reconstruction of the training observation 294. That is, the objective function 180 can minimize the amount of information (“capacity”) in the encoded representation, e.g., latent vector, of the training observation subject to satisfying a constraint on the distortion level of the reconstruction of the training observation from the decoder neural network 160. The target distortion level for the reconstruction can be fixed, e.g., can be received as input by the system 100 prior to training.

As described above, the capacity is the amount of information of the training observation that is represented in the latent vector and the distortion is a measure of the difference between the input training observation and the reconstruction.

In other words, the objective function 180 can train the encoder neural network to include the least amount of information about the training observation in the encoded representation that still allows the decoder neural network to reconstruct the input observation with at most a specified distortion.

Different training observations can require different capacity values to satisfy the fixed distortion value. More specifically, the amount of information represented in the latent vector for the training observation can be varied depending on the training observation. That is, to achieve the same distortion value, a first training observation may use more or less information than a second training observation. For example, training observation A 104 can require a different capacity value, e.g., a higher capacity value (meaning more information in the representation of the training observation) than training observation B and training observation C to satisfy the same distortion level. As a particular example, when the training observations are images, different images may depict scenes of varying complexity and therefore require different amounts of information to be encoded within the output of the encoder neural network for the decoder neural network to be able to effectively reconstruct the images.

The objective function 180 can be a loss function, and the encoder neural network 110 and the decoder neural network 160 can be trained to minimize the loss function.

As a specific example, the training system 100 can utilize an Augmented Lagrangian optimization method to train the models on a loss function using a per-observation Lagrange multiplier. More specifically, the objective function 180 can be a loss function that can include a (i) first loss term that represents the capacity and the constraint in terms of a per-observation Lagrange multiplier, and (ii) a second loss term for updating the per-observation Lagrange multiplier.

In some of these implementations, the encoder output also includes a Lagrangian output that defines the per-observation Lagrange multiplier for the objective function 180. For example, the encoder neural network 110 can generate an output that includes (i) an initial latent vector representing at least a portion of training observation A 104, (ii) a power output that defines a noise power for the initial latent vector, and (iii) a Lagrange multiplier for training observation A 104.

Further details of training the encoder neural network 110 and the decoder neural network on the objective function 180 are described below with reference to FIG. 2.

After the joint training, the encoded representations generated by the trained encoder neural network, e.g., the initial latent vector(s) and/or the final latent vector(s), can be used to perform one or more downstream tasks.

In some implementations, the initial latent vector(s) generated by the trained encoder neural network can be used to perform one or more downstream tasks.

In some implementations, the final latent vector(s) generated by the trained encoder neural network can be used to perform one or more downstream tasks.

As an example, the representations can be used for compression, e.g., so that the representations are used to reconstruct an input observation by the decoder neural network 160, as described above. For example, the system can use the final latent vector as part of the compressed representation directly or further compress the final latent vector using an appropriate compression technique, e.g., Huffman coding, Lempel-Ziv-Welch (LZW), run-length encoding (RLE), and so on to generate the compressed representation. In other words, the encoded representation, i.e., the initial or final latent vector(s), optionally after being further compressed using a compression technique, can be stored or transmitted as a compressed representation of the input observation. The compressed representation can be later accessed by a decompression system, e.g., from memory or over a network, which uses the decoder neural network to generate a reconstruction of the input observation from the encoded representation (optionally after being decompressed in accordance with the compression technique).

As yet another example, representations generated by the trained encoder neural network 110 can be provided as input to a downstream neural network for performing a downstream task.

For example, the representations generated by the encoder neural network 110 can be used to train a generative neural network that generates new observations (of the same type as the input observations or a different type) conditioned on representations generated using the encoder neural network.

As yet another example, the representations can be used as a representation of the observation for a multi-modal task performed by a multi-modal neural network, e.g., a representation of an image or video in visual understanding tasks, e.g., image (or video)-text retrieval tasks, image (or video) classification tasks, image (or video) captioning tasks, and visual question answering tasks. The multi-modal neural network can be, e.g., a multi-modal sequence generation neural network, e.g., a multi-modal large language model (LLM), or a visual language model (VLM), or a different type of multi-modal neural network. That is, the multi-modal neural network can process an input that includes an encoded representation of an input observation generated by the encoder neural network to perform a multi-modal task on the input, e.g., one of the tasks described above.

FIG. 2. is a diagram that illustrates an example training process of the example training system 200.

As described above, the training system 200 can train the decoder neural network 260 and the encoder neural network 210 to minimize the capacity of the encoded representation of the input observation subject to a target distortion. In this specification, the capacity of encoded representation of the input observation can represent the amount of information used to represent the input observation.

The training system 200 can minimize the capacity of the encoded representation of the input observation to an extent that will still maintain a specified distortion level, i.e., specified by the target distortion, by enforcing a constraint defined by a noise power to target a per-observation distortion value of the reconstruction.

To minimize the capacity of the encoded representation of the input observation subject to a target distortion, the training system 200 can use a constraint that is defined by the noise power because the more noise added, e.g., the higher the value of the noise power, the less information about the training observation is included in the representation of the training observation 204, e.g., the smaller the capacity, that is provided as input to the decoder neural network 260. Therefore, by adding a particular amount of noise, the system 200 can limit the amount of information that passes through the information bottleneck and is used to represent the training observation 204.

The training process is described with reference to a singular training observation in a set of training observations, e.g., training data set 102 of FIG. 1, that are used for a training iteration. The training system 200 can process the one or more training observations in the training data set in parallel during a training iteration.

The encoder 210 can receive a training observation 204 as input and can process the observation to generate an encoder output that includes (i) an initial latent vector 212, and (ii) a power output 214.

The initial latent vector 212 can be an encoded representation of (at least a portion of) the training observation 204. That is, the initial latent vector 212 is a lower-dimensional numerical representation of the training observation 204.

The power output 214 can define a noise power for the initial latent vector 212. M ore specifically, the noise power can represent the strength of the noise to be added to the initial latent vector 212.

The power output 214 is specific to the training observation 204. That is, different training observations will have different power outputs 214, and therefore, different noise powers.

In some implementations, the encoder output can further include (iii) a Lagrange multiplier 216 for the training observation 204. The usage of the Lagrange multiplier 216 is described in further detail below.

The system 200 can use the noise power, e.g., the strength of the noise, to minimize/constrain the signal power, e.g., the strength of the information, of the initial latent vector 212.

The system 200 can use the power output 214 to constrain the signal power of a final latent vector 222 by enforcing a power constraint 220 on the initial latent vector 212 to generate the final latent vector 222. That is, the signal power, e.g., the strength of the information of the training observation 204, can be limited using the power constraint 220.

In some implementations, the power constraint can constrain the signal power of the final latent vector 222 to be equal to one minus the noise power, as seen in the equation below, where z(x) is the final latent vector, ∥z(x)∥² represents the signal power of the final latent vector, and σ²(x) is the noise power of x:

$${‖ z ( x ) ‖}^{2} = 1 - {σ}^{2} ( x )$$

The system 200 can enforce the power constraint 220 by determining a scaling factor from the power output 214 and applying the scaling factor to the initial latent vector 212. The scaling factor can be computed so as to guarantee that the above power constraint is satisfied for the final latent vector 222. That is, the system 200 can constrain the signal power of the final latent vector 222 by scaling the initial latent vector 212 by a scaling factor defined by the noise power to generate a final latent vector 222.

The system 200 can determine the scaling factor from the power output 214 by determining a ratio of signal power (∥z′(x)∥²) of the initial latent vector z′(x) to noise power (σ²(x)) from the power output 214, as seen in the equation below:

$$ρ = \frac{{‖ {z}^{′} ( x ) ‖}^{2}}{{σ}^{2} ( x )}$$

In some implementations, the power output from the encoder neural network 210 directly represents the ratio ρ.

Alternatively, in some other implementations, determining the ratio (ρ) can include computing an exponential of the power output from the encoder neural network 210, as seen in the equation below where ρ represents the ratio and ρ′(x) represents the power output 214 from the encoder neural network 210:

$$ρ = {2}^{ρ′ ( x )}$$

In some implementations, by using an exponential of the power output from the encoder neural network 210 to compute the value of the ratio, the system 200 can accommodate a large dynamic range of ratios by compressing the wide range of ratios to a more manageable scale.

The above computation can be used to compute the value of the ratio when computing and/or applying the scaling factor to the initial latent vector 212 to generate the final latent vector 222. That is, to compute the scaling factor, e.g., apply the scaling factor to the initial latent vector 212, the system 200 can use the above computation of the ratio.

The system 200 can determine the scaling factor from a signal power of the initial latent vector 212 and the ratio.

The system 200 can define the noise power in terms of the ratio, as seen in the below equations, where @2 is the noise power (as defined above):

$$ρ ( x ) = \frac{{‖ {z}^{′} ( x ) ‖}^{2}}{{σ}^{2} ( x )} = \frac{1 - {σ}^{2} ( x )}{{σ}^{2} ( x )}$$

$${σ}^{2} = \frac{ρ}{1 + ρ}$$

Using the ratio of the signal power to the noise power and the power constraint (defined above), the system 200 can determine the noise power in terms of the ratio (ρ) by solving the first equation of the above equations in terms of the noise power (σ²). In some implementations, the noise power can be determined from the ratio, as seen above.

The system 200 can define the pre-noise latent power P_{z}, e.g., the signal power of the initial latent vector 212, in terms of the ratio (ρ) using the above noise power equation, as seen in the below equations:

$${P}_{z} = {‖ {z}^{′} ( x ) ‖}^{2}$$

$${σ}^{2} ( ρ ) = \frac{1}{1 + ρ} ( ρ )$$

$${σ}^{2} ( \frac{{‖ {z}^{′} ( x ) ‖}^{2}}{{σ}^{2} ( x )} ) = \frac{ρ}{1 + ρ}$$

$${P}_{z} = \frac{ρ}{1 + ρ}$$

As seen above, the equation of the noise power defined in terms of the ratio (ρ) can be used to define the pre-noise signal power in terms of the ratio (ρ) by multiplying both sides by the ratio and then solving for the pre-noise signal power.

The scaling factor (α) can then be defined using the pre-noise latent power, where k indicates the dimensionality of the latent vector, P_{z} represents the pre-noise latent power, and ∥z′(x)∥ represents the norm of the initial latent vector.

$$α = \frac{\sqrt{k}}{‖ {z}^{′} ( x ) ‖} \sqrt{{P}_{z}}$$

That is, in some implementations, the system 200 can enforce the constraint by normalizing the power of the initial latent vector z′(x).

The system 200 can apply the scaling factor to the initial latent vector 212 to generate a final latent vector 222 representing at least the portion of the training observation 204 and having a constrained power signal.

$$z ( x ) = α {z}^{′} ( x )$$

After generating the final latent vector 222, the training system 200 can add the noise to the final latent vector 222. More specifically, the training system 200 can add a scaled noise vector 232 to the final latent vector 222 to generate a noisy latent vector 252.

The training system can add a scaled noise vector 232 to the final latent vector 222 to generate a noisy latent vector 252 using any appropriate method.

For example, the scaled noise vector 232 can be added to the final latent vector 222 using element-wise addition.

The scaled noise vector 232 can include scaled noise values that have been scaled using a factor that depends on the noise power defined by the power output 214 and a noise vector 230. More specifically, the training system 200 can sample the noise vector 230 from a noise distribution and scale the noise vector 230 using a factor that is defined by the noise power to generate the scaled noise vector 230.

For example, the noise distribution can be a Gaussian noise distribution. The training system 200 can generate values for the noise vector that follow a Gaussian distribution, e.g., that are normally distributed around the specified mean and standard deviation.

The noisy latent vector 252 can be defined as seen below, where (\hat{z}) represents the noisy latent vector 252, (z) represents the final latent vector 222, and the scaled noise vector is represented by the second term that includes the factor (σ) defined by the noise power (σ²) and a noise vector 230 that follow a Gaussian distribution ( [symbol] (0, I)).

$$\hat{z} = z + σ * ℕ ( 0 , I )$$

In some implementations, scaling the noise vector using a factor that is defined by the noise power to generate a scaled noise vector can include multiplying the noise vector by a square root of the noise power. That is, in some implementations, after enforcing the power constraint, the output can be defined a factor of the noise power that is equal to the square root of the noise power (σ²).

$$\hat{z} = z + \sqrt{{σ}^{2}} * ℕ ( 0 , I )$$

The decoder neural network 260 can process a decoder input that includes the noisy latent vector 252 to generate a reconstruction of the training observation 294.

Using the reconstruction of the training observation 294, the training system 200 can train the decoder neural network 260 and the encoder neural network 210 jointly on a loss function that aims to minimize the capacity of the latent vector of the training observation 204, subject to a per-observation distortion constraint on of the reconstruction of the training observation 294.

To define the distortion constraint, the system 200 can compute the distortion 270 of the reconstruction of the training observation.

The system can compute the distortion 270 using any appropriate method for determining an error between the training observation and the reconstruction. For example, the distortion 270 can be the mean-squared error between the training observation and the reconstruction.

The system can compare the computed distortion 276 with the target distortion 274 to define the following distortion constraint, where δ is the target distortion, xᵢ represents the training observation 204, and \hat{x}_{i,θ} represents the reconstruction of the training observation 294:

$$Δ ( {x}_{i} , {\hat{x}}_{i , θ} ) \leq δ$$

That is, to satisfy the distortion constraint, the distortion of the reconstruction (Δ(xᵢ,\hat{x}_{i,θ}) of the image must be less than or equal to the target distortion (δ).

In some implementations, for high-dimensional data, e.g., images, the distortion constraint can be represented by an equality constraint:

$$Δ ( {x}_{i} , {\hat{x}}_{i , θ} ) = δ$$

The system 200 can compute the training loss 280 of the training observation by using the target distortion 274, and the computed distortion 276 of the reconstruction of the training observation to define the distortion constraint in a loss function.

The target distortion 274 represents the fixed distortion value for the input observations. The target distortion 274 can be preconfigured. That is, the target distortion 274 can be manually determined and input into the training system 200.

The distortion constraint can be defined as follows, using the distortion equality constraint above, where h_{θ}(xᵢ) represents the distortion constraint:

$${h}_{θ} ( {x}_{i} ) = Δ ( {x}_{i} , {\hat{x}}_{i , θ} ) - δ$$

As mentioned above, in some implementations, the encoder output can further include a Lagrangian output that defines a per-observation Lagrange multiplier 216 for the loss function. That is, the encoder neural network 210 can output a Lagrange multiplier 216 for the training observation 204.

In some implementations, the loss function can include (i) a first loss term that represents the capacity and the constraint in terms of the per-observation Lagrange multiplier 216, and (ii) a second loss term for updating the per-observation Lagrange multiplier 216.

As one example, the loss Lc can be represented as:

$${L}_{c} = {c}_{θ} ( {x}_{i} ) + λ ( {x}_{i} ) {h}_{θ} ( {x}_{i} ) + {w}_{t} {h}_{θ} ( {x}_{i} ) [ η \vert \vert {∇}_{θ} {λ}_{θ} ( {x}_{i} ) {\vert \vert}^{2} ]$$

The first loss term (c_{θ}(xᵢ)+λ(xᵢ)h_{θ}(xᵢ)) can represent the capacity co (xᵢ) of the latent vector of the training observation and the constraint in terms of the per-observation Lagrange multiplier 216 (λ(xᵢ)h_{θ}(xᵢ)), where λ(xᵢ) is the per-observation Lagrange multiplier for the training observation and h_{θ}(xᵢ) is the distortion constraint.

The capacity (c_{θ}(xᵢ)) of the latent vector of the training observation can be determined for the training observation using the below equation, where k represents the dimensionality of the latent vector representation of the training observation, and σ² represents the noise power of the latent vector:

$$c ( x ) = \frac{k}{2} {log}_{2} ( {σ}^{2} )$$

The capacity of the latent vector of the training observation can be defined by the logarithm of the noise power of the latent vector, instead of the ratio of the signal power and noise power of the latent vector. By introducing the power constraint above, only the noise power controls the signal-to-noise ratio, and the capacity can solely depend on the noise power.

The second loss term wₜh_{θ}(xᵢ)[η∥∇_{θ}λ_{θ}(xᵢ)∥²] can be used for updating the per-observation Lagrange multiplier 216, where wₜ is a constant that is increased according to a pre-defined schedule as the optimization progresses, h₇₄ (xᵢ) is the constraint, and [η∥∇_{θ}λ_{θ}(xᵢ)∥²] represents a scale factor that depends on the learning rate (η) and gradient magnitude (∇_{θ}), e.g., the magnitude of the gradient of the Lagrange multiplier 216 with respect to the model parameters. When a different optimizer, e.g., A dam, A dafactor, and so on, is used, the second loss term can have a different formulation than the one given above.

The training system 200 can train the decoder neural network and the encoder neural network by computing a gradient of the objective function with respect to the parameters of the decoder and the encoder, e.g., through backpropagation. The training system 200 can then apply an optimizer to the gradients to update the parameters of the decoder and encoder.

Thus, the training system 200 can train the encoder neural network 110 and decoder neural network 160 to minimize the capacity of the encoded representation of a training observation subject to a per-observation distortion constraint.

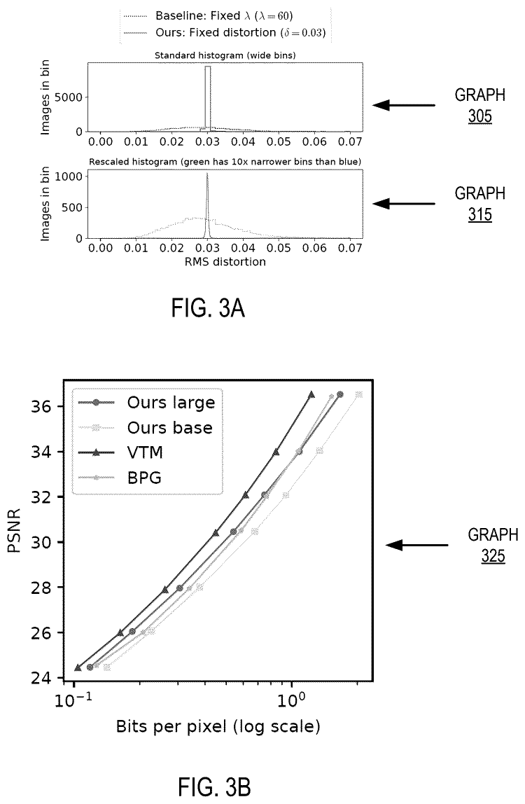

FIG. 3A illustrates the ability of the trained encoder to target distortion.

Graphs 305 and 315 are histograms of image distortions of the fixed distortion technique described in this application and a classical technique, where information capacity is held fixed.

The difference between the two techniques is so extreme that for visualization purposes it is helpful to use different histogram bin widths for each technique, as seen in graph 315.

The technique described in this specification is able to precisely target distortion, indicated by the narrow distortion histogram, as seen in both graph 305 and graph 315, while the classical technique produces a wide range of distortions.

To target distortion, the system can receive a specified distortion as input and then match the distortion level in the generated reconstructions of the input observations. For example, as seen in Graph 305, the system can receive a target distortion level of 0.03 and match the 0.03 distortion as closely as possible in each of the reconstructions generated by the system. As seen in the distortion histograms of graph 305 and 315, the system is very successful in matching the target distortion.

By precisely targeting distortion, the system can dynamically adapt to different compression requirements and be more flexibly tailored to particular use cases. For example, for a medical imaging application, the system can target a particularly low distortion level as high accuracy in image reconstruction is crucial for diagnosis. As another example, on an edge device, the system can target a higher distortion to handle computational constraints, balancing computational limitations and reconstruction quality. FIG. 3B illustrates the performance of the trained encoder in comparison with other classical algorithms.

Graph 325 compares the quality of reconstruction using a rate-distortion curve to evaluate the trade-off between the rate (e.g., the capacity, or amount of information used to represent the observation) and the distortion for an image.

As seen in graph 325, the information content of images as measured by the techniques described in this specification is similar to that measured by classical image compression algorithms. That is, the compression rate of the system described in this specification can match the compression rates of classical algorithms.

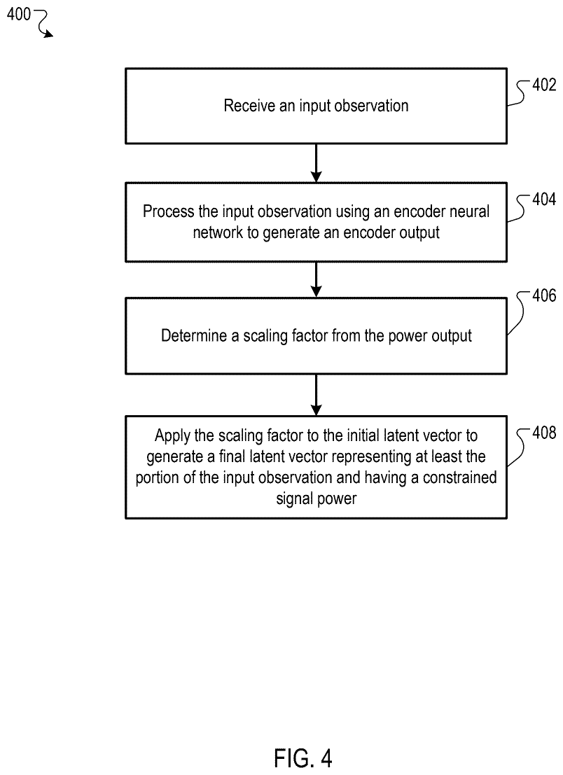

FIG. 4 is a flow diagram of an example process of constraining the signal power of an encoded representation.

For convenience, the process 400 will be described as being performed by a system of one or more computers located in one or more locations. For example, a training system, e.g., the training system 100 depicted in FIG. 1, appropriately programmed in accordance with this specification, can perform the process 400.

The training system receives an input observation (step 402).

The input observation can be any appropriate input observation. In some implementations, the input observation is an image. In some implementations, the input observation is audio data representing an audio signal. In some implementations, the input observation is a video.

The system processes the input observation using an encoder neural network to generate an encoder output (step 404).

The system can be configured to process any variety of types of input observations.

For example, the input observations can be images, i.e., so that the encoder neural network 110 can process the intensity values of the pixels of the images.

As another example, the input observations can be audio data that represent audio signals, e.g., audio waveforms, compressed or companded audio waveforms, or spectrograms.

As another example, the input observations can be videos, i.e., so that the encoder neural network 120 can process the intensity values of the pixels of the video frames of the video frames in the video.

As another example, the input observations can be other types of sensor data, e.g., point clouds representing Lidar readings, radar readings, and so on.

The encoder output can include (i) an initial latent vector representation at least a portion of the input observation and (ii) a power output that defines a noise power for the initial latent vector.

The system can determine a scaling factor from the power output (step 406).

The system can enforce the power constraint to constrain the signal power of the final latent vector by determining a scaling factor from the power output and applying the scaling factor to the initial latent vector. The scaling factor can be determined so as to guarantee that the power constraint is satisfied for the final latent vector.

In some implementations, the system can determine the scaling factor from the power output by determining a ratio of signal power to noise power from the power output. As described above, in some cases the power output directly represents the ratio while, in other cases, the system transforms the power output to generate the ratio.

The process of determining the scaling factor is described in further detail above with reference to FIG. 2.

The scaling factor (α) can then be defined, where k indicates the dimensionality of the latent vector, P_{z} represents the pre-noise latent power, and ∥z′(x)∥ represents the norm of the initial latent vector.

$$α = \frac{\sqrt{k}}{‖ {z}^{′} ( x ) ‖} \sqrt{{P}_{z}}$$

The system can apply the scaling factor to the initial latent vector to generate a final latent vector representing at least the portion of the input observation and having a constrained signal power (step 408).

The application of the scaling factor to the initial latent vector to generate a final latent vector can be represented by the below equation:

$$z ( x ) = α {z}^{′} ( x )$$

That is, the system can scale the initial latent vector by the scaling factor to compute the final latent vector. By applying the scaling factor, the system can enforce the power constraint and thus, constrain the capacity of the final latent vector.

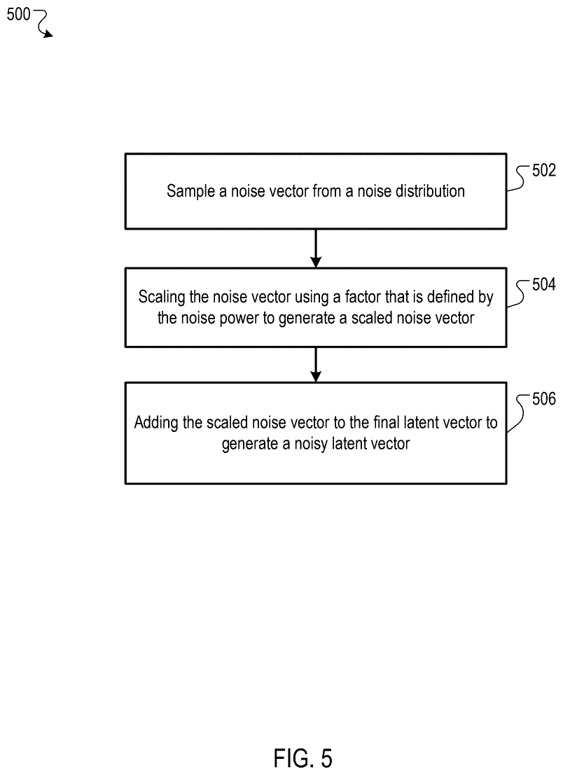

FIG. 5 is a flow diagram of an example process of adding noise to the constrained encoded representation.

For convenience, the process 500 will be described as being performed by a system of one or more computers located in one or more locations. For example, a training system, e.g., the training system 100 depicted in FIG. 1, appropriately programmed in accordance with this specification, can perform the process 500.

The training system can sample a noise vector from a noise distribution (step 502).

The noise distribution can be any appropriate noise distribution, such as Gaussian, Poisson, etc.

In some implementations, the noise distribution is a Gaussian noise distribution.

The training system can sample a noise vector from a noise distribution using any appropriate method.

The sampling process is described in further detail above with reference to FIG. 2.

The system can scale the noise vector using a factor that is defined by the noise power to generate a scaled noise vector (step 504).

In some implementations, scaling the noise vector using a factor that is defined by the noise power to generate a scaled noise vector can include multiplying the noise vector by a square root of the noise power. That is, in some implementations, after enforcing the power constraint, the output can define a factor of the noise power that is equal to the square root of the noise power.

The system can add the scaled noise vector to the final latent vector to generate a noisy latent vector (step 506).

The noisy latent vector 252 can be defined as seen below, where (\hat{z}) represents the noisy latent vector 252, (z) represents the final latent vector 222, and the scaled noise vector is represented by the second term that includes the factor (σ) defined by the noise power (σ²) and a noise vector 230 that follow a Gaussian distribution ( [symbol] (0, I)).

$$\hat{z} = z + σ * ℕ ( 0 , I )$$

In some implementations, scaling the noise vector using a factor that is defined by the noise power to generate a scaled noise vector can include multiplying the noise vector by a square root of the noise power. That is, in some implementations, after enforcing the power constraint, the output can be defined a factor of the noise power that is equal to the square root of the noise power (σ²).

$$\hat{z} = z + \sqrt{{σ}^{2}} * ℕ ( 0 , I )$$

The system can add the scaled noise vector to the final latent vector using any appropriate method, including element-wise addition, and scalar multiplication and then addition.

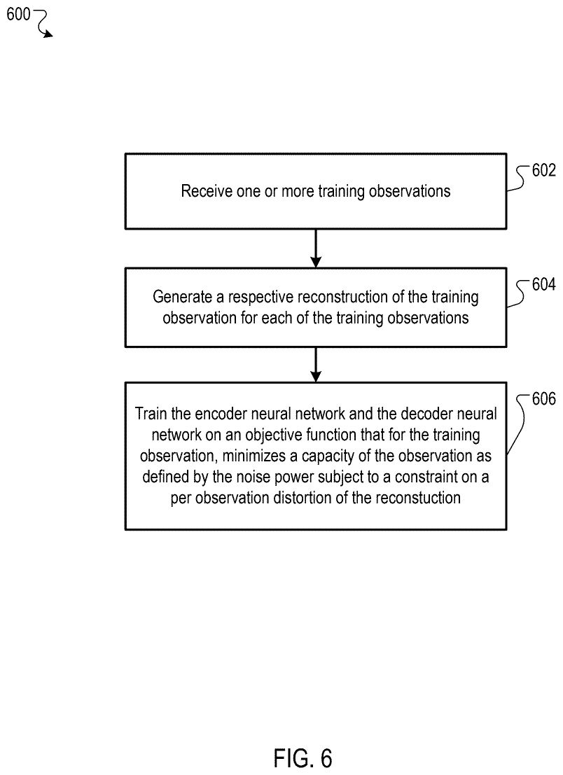

FIG. 6 is a flow diagram of an example training iteration for training the encoder and decoder neural networks.

For convenience, the process 600 will be described as being performed by a system of one or more computers located in one or more locations. For example, a training system, e.g., the training system 100 depicted in FIG. 1, appropriately programmed in accordance with this specification, can perform the process 600.

The training system receives one or more training observations (step 602).

The below steps (604-606) can be completed for each training observation of the one or more training observations for the training iteration.

The training system processes the training observation using the encoder neural network to generate an encoder output that includes an initial latent vector, e.g., encoded representation, of the training observation.

Further details of the encoder output and generation process are described above with reference to FIGS. 1 and 2.

The training system enforces a power constraint on the initial latent vector to generate a final latent vector. Further details of the power constraint and the generation of a final latent vector are described above with reference to FIG. 2.

In some implementations, the final latent vector can be combined with a scaled noise vector to generate a noisy latent vector. Further details of the scaled noise vector and the generation of a noisy latent vector are described above with reference to FIG. 2.

The training system can generate a respective reconstruction of the training observation for each of the training observations (step 604).

Using a decoder neural network, the system can generate a respective reconstruction of the training observation from the final latent vector for the training observation.

In some implementations, the system can generate a respective reconstruction of the training observation from the noisy latent vector for the training observation.

The generation of a respective reconstruction of the training observation is described in further detail above with reference to FIG. 1.

The training system trains the encoder neural network and the decoder neural network on an objective function that for the training observation, minimizes a capacity of the encoded representation of the observation as defined by the noise power subject to a constraint on a per-observation distortion of the reconstruction of the training observation relative to the training observation (step 606).

The training system can train the encoder neural network and the decoder neural network using an objective function.

The objective function can be any appropriate objective function that is optimized during training to update the parameters of the encoder neural network and the decoder neural network.

In some implementations, the objective function is a loss function.

In some implementations, the objective function is a loss function that can include (i) a first loss term that represents the capacity and the constraint in terms of the per-observation Lagrange multiplier 216, and (ii) a second loss term for updating the per-observation Lagrange multiplier 216, as seen in the equation below.

$${L}_{c} = {c}_{θ} ( {x}_{i} ) + λ ( {x}_{i} ) {h}_{θ} ( {x}_{i} ) + {w}_{t} {h}_{θ} ( {x}_{i} ) [ η {‖ {∇}_{θ} {λ}_{θ} ( {x}_{i} ) ‖}^{2} ]$$

The first loss term (c_{θ}(xᵢ)+ζ(xᵢ)h₇₄ (xᵢ)) can represent the capacity c_{θ}(xᵢ) of the latent vector of the training observation and the constraint in terms of the per-observation Lagrange multiplier 216 (λ(xᵢ)h₇₄ (xᵢ)), where λ(xᵢ) is the per-observation Lagrange multiplier for the training observation and h₇₄ (xᵢ) is the constraint.

The capacity (c_{θ}(xᵢ)) of the latent vector of the training observation can be determined for the training observation using the below equation, where k represents the dimensionality of the latent vector representation of the training observation, and σ² represents the noise power of the latent vector:

$$c ( x ) = \frac{k}{2} {log}_{2} ( {σ}^{2} )$$

The capacity of the latent vector of the training observation can be defined by the logarithm of the noise power of the latent vector, instead of the ratio of the signal power and noise power of the latent vector. By introducing the power constraint above, only the noise power controls the signal-to-noise ratio, and the capacity can solely depend on the noise power.

The second loss term wₜh₇₄ (xᵢ) [η∥∇_{θ}λ_{θ}(xᵢ)∥²] can be used for updating the per-observation Lagrange multiplier, where wₜ is a constant that is increased according to a pre-defined schedule as the optimization progresses, h₇₄ (xᵢ) is the constraint, and [η∥∇_{θ}λ_{θ}(xᵢ)∥²] represents a scale factor that depends on the learning rate (η) and gradient magnitude (∇_{θ}) of the gradient optimizer for the model, e.g., the magnitude of the gradient of the Lagrange multiplier 216 with respect to the model parameters.

The training system can train the decoder neural network and the encoder neural network by computing a gradient of the objective function with respect to the parameters of the decoder and the encoder through backpropagation. The system can then apply an optimizer to the gradients to update the parameters of the decoder and encoder.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an A pache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are correspond toed in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes correspond toed in the accompanying figures do not necessarily require the particular order shown, or sequential order, to achieve desirable results. In some cases, multitasking and parallel processing may be advantageous.

1. A method performed by one or more computers, the method comprising:
receiving an input observation;
processing the input observation using an encoder neural network to generate an encoder output that comprises:
(i) an initial latent vector representing at least a portion of the input observation; and
(ii) a power output that defines a noise power for the initial latent vector;
determining a scaling factor from the power output; and
applying the scaling factor to the initial latent vector to generate a final latent vector representing at least the portion of the input observation and having a constrained signal power.

2. The method of claim 1, wherein the input observation is an image.

3. The method of claim 1, wherein the input observation is audio data representing an audio signal.

4. The method of claim 1, wherein the input observation is a video.

5. The method of claim 1, further comprising:
sampling a noise vector from a noise distribution;
scaling the noise vector using a factor that is defined by the noise power to generate a scaled noise vector; and
adding the scaled noise vector to the final latent vector to generate a noisy latent vector.

6. The method of claim 5, wherein scaling the noise vector using a factor that is defined by the noise power to generate a scaled noise vector comprises multiplying the noise vector by a square root of the noise power.

7. The method of claim 5, further comprising:
processing a decoder input comprising the noisy latent vector using a decoder neural network to generate a reconstruction of the input observation.

8. The method of claim 7, further comprising:
training the decoder neural network and the encoder neural network jointly on an objective that, for the input observation, minimizes a capacity of the input observation as defined by the noise power subject to a constraint on a per-observation distortion of the reconstruction of the input observation relative to the input observation.

9. The method of claim 8, wherein:
the encoder output further comprises a Lagrangian output that defines a per-observation Lagrange multiplier for the objective, and
the objective comprises:
a first loss term that represents the capacity and the constraint in terms of the per-observation Lagrange multiplier, and
a second loss term for updating the per-observation Lagrange multiplier.

10. The method of claim 1, wherein applying the scaling factor to the initial latent vector constrains the final latent vector to have a signal power that is equal to one minus the noise power.

11. The method of claim 1, wherein determining a scaling factor from the power output comprises:
determining a ratio of signal power to noise power from the power output; and
determining the scaling factor from a signal power of the initial latent vector and the ratio.

12. The method of claim 11, wherein determining the ratio comprises computing an exponential of the power output.

13. The method of claim 11, further comprising:
determining the noise power from the ratio.

14. The method of claim 1, further comprising:
processing an input derived from the final latent vector using a downstream neural network to perform a downstream task.

15. The method of claim 14, wherein the downstream task is a classification task.

16. The method of claim 14, wherein the downstream task is a multi-modal task.

17. The method of claim 14, wherein the input comprises the noisy latent vector.

18. A system comprising:
one or more computers; and
one or more storage devices communicatively coupled to the one or more computers, wherein the one or more storage devices store instructions that, when executed by the one or more computers, cause the one or more computers to perform operations comprising:
receiving an input observation;
processing the input observation using an encoder neural network to generate an encoder output that comprises:
(i) an initial latent vector representing at least a portion of the input observation; and
(ii) a power output that defines a noise power for the initial latent vector;
determining a scaling factor from the power output; and
applying the scaling factor to the initial latent vector to generate a final latent vector representing at least the portion of the input observation and having a constrained signal power.

19. The system of 18, the operations further comprising:
sampling a noise vector from a noise distribution;
scaling the noise vector using a factor that is defined by the noise power to generate a scaled noise vector;
adding the scaled noise vector to the final latent vector to generate a noisy latent vector;
processing a decoder input comprising the noisy latent vector using a decoder neural network to generate a reconstruction of the input observation; and
training the decoder neural network and the encoder neural network jointly on an objective that, for the input observation, minimizes a capacity of the input observation as defined by the noise power subject to a constraint on a per-observation distortion of the reconstruction of the input observation relative to the input observation.

20. One or more non-transitory computer storage media storing instructions that when executed by one or more computers cause the one or more computers to perform operations comprising:
receiving an input observation;
processing the input observation using an encoder neural network to generate an encoder output that comprises:
(i) an initial latent vector representing at least a portion of the input observation; and
(ii) a power output that defines a noise power for the initial latent vector;
determining a scaling factor from the power output; and
applying the scaling factor to the initial latent vector to generate a final latent vector representing at least the portion of the input observation and having a constrained signal power.
